(19) United States
(12) Patent Application Publication
(10) Pub. No.: US 2023/0143904 A1
(43) Pub. Date: May 11, 2023

(54) Computer System and Method for Solving Pooling Problem as an Unconstrained Binary Optimization

(71) Applicant: Zapata Computing, Inc., Boston, MA (US)

(72) Inventor: Yudong Cao, Cambridge, MA (US)

(21) Appl. No.: 17/918,222

(22) PCT Filed: Apr. 20, 2021
(86) PCT No.: PCT/US2021/028077

§ 371 Date: Oct. 11, 2022

Related U.S. Application Data
(60) Provisional application No. 63/012,585, filed on Apr. 20, 2020.

(51) Int. Cl. G06N 10/20; G06N 10/60

(52) U.S. Cl. CPC G06N 10/20; G06N 10/60

(57) ABSTRACT

A computer optimizes transport of a set of ingredients between a plurality of sources, at least one terminal, and a plurality of pools, described by an objective function, a set of variables, and a set of constraints, by: (A) transforming the objective function, variables, and constraints into a binary cost function, including: discretizing the set of variables into a set of a binary variables; transforming the objective function into a binary cost function of the set of binary variables; and adding, for each constraint in the set of constraints, one or more terms to the binary cost function, to create a completed cost function; and (B) providing the completed cost function to a solver to obtain a solution or approximate solution representing a flow of the set of ingredients between the plurality of sources, the plurality of pools, and the at least one terminal.

### BACKGROUND

The pooling problem has widespread applications across petrochemical engineering, wastewater treatment and mining. The problem concerns finding the optimal scheme for transporting a starting set of mixtures of ingredients in a set of sources to a set of terminals through a set of pools. The pooling problem may be used to model, for example, an important petrochemical process wherein crude oil and other ingredients are blended in one or more pools with one or more other sources to produce one or more final products. A solution to the pooling problem produces a low-cost flow-rate in a network to generate the desired products. For example, a desired final product of gasoline with specific constraints on octane number may be produced by mixing intermediate streams from reforming, cracking, and naphtha treatment units. Pooling problems are sometimes used in solving other physical problems as well.

### SUMMARY

A computer optimizes transport of a set of ingredients between a plurality of sources, at least one terminal, and a plurality of pools, described by an objective function, a set of variables, and a set of constraints, by: (A) transforming the objective function, the set of variables, and the set of constraints into a binary cost function, including: (A)(1) discretizing the set of variables into a set of a binary variables; (A)(2) transforming the objective function into a binary cost function of the set of binary variables; and (A)(3) adding, for each constraint in the set of constraints, one or more terms to the binary cost function, to create a completed cost function; and (B) providing the completed cost function to a solver to obtain a solution or approximate solution representing a flow of the set of ingredients between the plurality of sources, the plurality of pools, and the at least one terminal.

Other features and advantages of various aspects and embodiments of the present invention will become apparent from the following description and from the claims.

### BRIEF DESCRIPTION OF THE FIGURES

FIG. 1 is a diagram of a quantum computer according to one embodiment of the present invention;

FIG. 2A is a flowchart of a method performed by the quantum computer of FIG. 1 according to one embodiment of the present invention;

FIG. 2B is a diagram of a hybrid quantum-classical computer which performs quantum annealing according to one embodiment of the present invention;

FIG. 3 is a diagram of a hybrid quantum-classical computer according to one embodiment of the present invention;

FIG. 4 is a flowchart of a method performed by one embodiment of the present invention to optimize transport of a set of ingredients between a plurality of sources, at least one terminal, and a plurality of pools; and

FIG. 5 is a diagram illustrating schematics of a generalized pooling problem according to one embodiment of the present invention.

### DETAILED DESCRIPTION

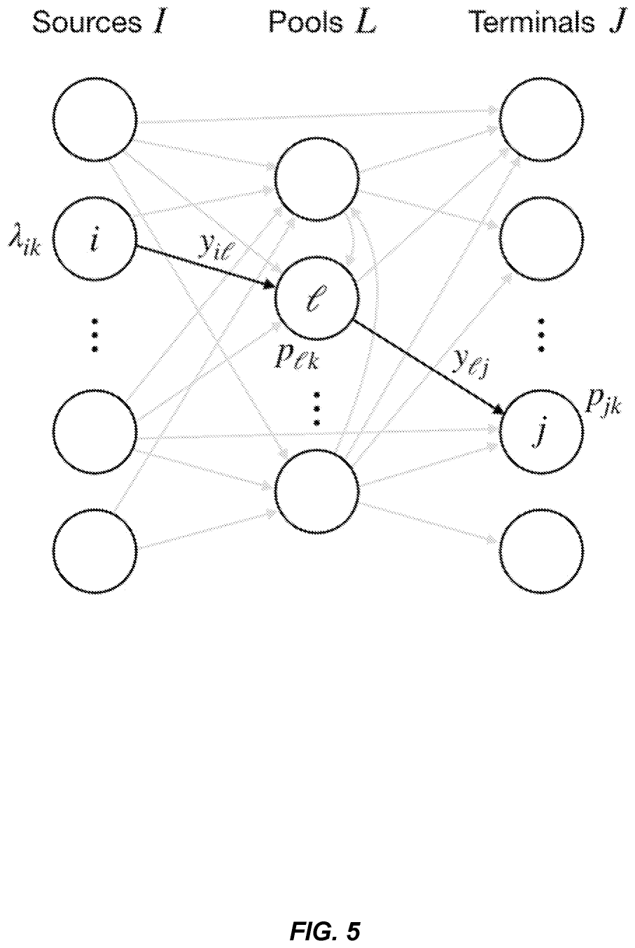

The pooling problem has widespread applications across petrochemical engineering, wastewater treatment and mining. As is shown in FIG. 5, the problem concerns finding the optimal scheme for transporting a starting set of mixtures of ingredients in the sources Ito the terminals J through a set of pools L. The pooling problem may be used to model, for example, an important petrochemical process wherein crude oil and other ingredients are blended in one or more pools with one or more other sources to produce one or more final products. A solution to the pooling problem produces a low-cost flow-rate in a network to generate the desired products. For example, a desired final product of gasoline with specific constraints on octane number may be produced by mixing intermediate streams from reforming, cracking, and naphtha treatment units. Pooling problems are sometimes used in solving other physical problems as well.

Although particular numbers of the sources I, terminals J, and pools L are shown in FIG. 5, these numbers are merely examples and do not constitute limitations of the present invention. Embodiments of the present invention may be used in connection with any numbers of sources I, terminals J, and pools L, in any combination. Furthermore, although the terminals J are referred to herein in the plural, in practice there may be as few as one terminal J. Therefore, any reference herein to the terminals J should be understood to refer to at least one terminal J. Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

As described above, embodiments of the present invention may include methods and systems which find an optimal scheme for transporting a set of mixtures of ingredients in the sources I to the terminals J through a set of pools L. The sources I may be physical sources of the ingredients (e.g., oil). Similarly, the terminals J and pools L may be physical terminals and pools, respectively, in which various amounts of the ingredients may be stored and/or transported through. Embodiments of the present invention may include computer-implemented methods and systems which use data, stored on at least one non-transitory computer-readable medium, to represent the sources I, the terminals J, and the pools L. References herein to the sources I, pools L, and terminals J should be understood to refer to such data.

In practice, outputs of embodiments of the present invention may specify amounts of ingredients, such as amounts of ingredients to store in the sources I or amounts of mixtures of ingredients to transport between sources I, terminals J, and pools L. Upon and in response to generating such outputs, the amounts of ingredients specified by such outputs may be stored in the corresponding physical sources.

Each terminal j has a specific demand on the concentration pⱼ of the ingredient k ∈ K being in a specific interval μⱼₖ^{min}≤pⱼₖ≤μⱼₖ^{max}. Here K is the set of all ingredients supplied by the sources. Accordingly, each pool l has a concentration pₗₖ of ingredient k. Each source i has a prescribed concentration of ingredient k which we denote as λᵢₖ. The connectivity between the three sets of nodes is such that each source only emits out-degrees to other nodes and each terminal only receives in-degrees from other nodes. Each pool node can have both in-degrees and out-degrees. For standard pooling problems, the in-degrees can only come from sources and the out-degrees can only go to a terminal. For generalized pooling problems, both in-degrees and out-degrees of a pool node can connect from and to other pools. Embodiments of the present invention may be applied to generalized pooling problems. In more formal terms, the set of directed edges A ⊆ (I ∪ L)×(L ∪ J).

The independent variables that are optimized for the pooling problem in certain embodiments of the present invention are the amount of flow yᵢⱼ from node i to j such that the total cost Σ_{(i,j)∈A}cᵢⱼyᵢⱼ is minimized. Here the cost cᵢⱼ associated with each edge can be appreciated as the expense incurred from the sources (such as mining, refining, and manufacturing) leading to cᵢⱼ>0 for i ∈ I as well as the profit gained from the terminals (such as sales profit) yielding cᵢⱼ>0 for j ∈ J.

A feasible flow may, for example, satisfy one or more of the following constraints:
1. Each pipe from node i to j has a finite capacity μᵢⱼ>0. (A pipe in the model of FIG. 5 may correspond to any flow between two nodes, such as may be implemented, for example, in the form of a physical pipe or other physical conduit in a physical system modeled by the model of FIG. 5.) So we have

0≤yᵢⱼ≤μᵢⱼ.
2. Each pool [symbol] ∈ L and terminal j ∈ J has finite capacity for receiving inputs from the in-degrees:

$${\sum }_{i ∈ I ⋃ L} {y}_{i ℓ} \leq {u}_{ℓ} , \qquad ∀ ℓ ∈ L ; \qquad \begin{matrix}{\sum }_{i ∈ I ⋃ L} {y}_{ij} \leq {u}_{j} , & ∀ j ∈ J .\end{matrix}$$

3. Each source i ∈ I has finite capacity for providing outputs from its out-degrees:

$${\sum }_{ℓ ∈ L ⋃ J} {y}_{i ℓ} \leq {u}_{i} , \qquad ∀ i ∈ I .$$

4. Each pool [symbol] ∈ L has no capacity to store any flow, implying that the total flow from the in-degrees needs to balance that of the out-degrees:

$${\sum }_{i ∈ I ⋃ L} {y}_{i ℓ} = {\sum }_{j ∈ L ⋃ J} {y}_{ℓ j} .$$

Denote a flow that satisfies the above constraints 1-4 as F={yᵢⱼ|i ∈ I ∪ L, j ∈ L ∪ J, Constraints 1-4). Building on top of F, the dynamics of how the concentrations of various ingredients k changes from node to node are now discussed. Let pᵢₖ be the concentration of ingredient k at node i. Then the following is true:
A. By definition, pᵢₖ=λᵢₖ, ∀i ∈ I.
B. For each pool [symbol] ∈ L the value of [symbol] can be evaluated based on the concentrations from the in-degrees:

$${p}_{ℓ k} = \frac{{\sum }_{i ∈ I} {λ}_{ik} {y}_{i ℓ} + {\sum }_{{ℓ}^{′} ∈ L ∖ \{ ℓ \}} {p}_{{ℓ}^{′} k} {y}_{{ℓ}^{′} ℓ}}{{\sum }_{i ∈ I ⋃ L ∖ \{ ℓ \}} {y}_{i ℓ}} .$$

C. For each terminal j ∈ J the concentration of ingredient k can be evaluated similarly:

$${p}_{jk} = \frac{{\sum }_{i ∈ I} {λ}_{ik} {y}_{ij} + {\sum }_{ℓ ∈ L} {p}_{ℓ k} {y}_{ℓ j}}{{\sum }_{i ∈ I ⋃ L} {y}_{ij}} .$$

In addition, for the terminals, the constraints are such that μⱼₖ^{min}≤pⱼₖ≤μⱼₖ^{max}.

One could very well consider the concentration parameters p as dependent variables for the optimization problem, while the flow variables y are independent variables. This gives rise to the “p-formulation” of the pooling problem:

$${min}_{y , p} {\sum }_{( i , j ) ∈ A} {c}_{ij} {y}_{ij} , \qquad s . t . \qquad y ∈ F , \qquad Constraints A , B , C .$$

Given the formulation of the pooling problem, one could proceed with either special cases that are provably solvable or in the cases where the problem in indeed hard (NP-hard in the worst case), one would pursue various relaxation methods for approximating the pooling problem with a form such as linear programming that is easier to solve.

Embodiments of the invention pursue a different route that maps this problem to an unconstrained binary optimization problem, which is also NP-hard in the worst case, while introducing as few restrictions or relaxations as possible. The approach taken by embodiments of the present invention has not been of interest in the past possibly because intuitively one would think that the effort of transforming one optimization problem to another should be justified by the latter being somehow “simpler” than the former. However, we have discovered that the advent of hardware dedicated to solving these unconstrained binary optimization problems, such as quantum annealers, digital annealers, and various quantum-inspired heuristics, makes such effort worthwhile at least for useful optimization problems such as the pooling problem.

Embodiments of the present invention may include a solver that comprises a computer (e.g., a classical computer, quantum computer, or hybrid quantum-classical computer) and/or other hardware that is suited to solving, or approximately solving, binary optimization problems. Examples of solvers for binary optimization problems implemented on quantum annealers or quantum computers which may be used by embodiments of the present invention include, for example, those described in the following papers, which are hereby incorporated by reference herein:
Vicky Choi, “Minor-Embedding in Adiabatic Quantum Computation: I. The Parameter Setting Problem,” Quantum Information Processing, 7, pp 193-209, 2008.
Vicky Choi, “Minor-embedding in adiabatic quantum computation: II. Minor-universal graph design,” Quantum Information Processing: Volume 10, Issue 3 (2011), p 343.
Ryan Babbush et al., “Resource Efficient Gadgets for Compiling Adiabatic Quantum Optimization Problems,” Annalen der Physik: Volume 25, 10-11 (2013).

Embodiments of the present invention may also include solvers implemented on digital annealers or classical computers utilizing quantum-inspired algorithms. Quantum-inspired algorithms include, for example, those described in the following paper, which is hereby incorporated by reference herein:
Hossein Nezamabadi-pour, “A quantum-inspired gravitational search algorithm for binary encoded optimization problems,” Engineering Applications of Artificial Intelligence, Volume 40, 62-75 (2015).

Embodiments of the present invention discretize the domain on which the variables dwell, such as by approximating each variable x ∈ [c₁, c₂] with a binary expansion \hat{x}=c₁+c₂Σₜ2^{-t}b^{(t)} where b^{(t)} ∈ {0,1}. For approximation error |x−\hat{x}|≤ε, it takes only [log₂ ε⁻¹] bits. Hence, embodiments of the present invention may transform the objective function stated previous in the p-formulation to the binary function

$${H}_{cost} ( \hat{y} ) = {\sum }_{( i , j ) ∈ A} {c}_{ij} {\hat{y}}_{ij} ,$$

where each ŷᵢⱼ terms is a discretized form of yᵢⱼ in a binary expansion of S_{y} bits:

$${\hat{y}}_{ij} = U {\sum }_{t = 1}^{{S}_{y}} {2}^{- t} {b}_{ij}^{( t )} , {b}_{ij}^{( t )} ∈ \{ 0 , 1 \} .$$

Here

$$U = {max}_{i , j} {u}_{ij} .$$

The total approximation error in the cost function due to this discretization is then O(CU2^{-S}) with

$$C = {max}_{i , j} \vert {c}_{ij} \vert .$$

Embodiments of the present invention remove the equality and inequality constraints imposed on the problem. For equality constraints of the form f(x)=g(x) where f, g are polynomials (in the case of pooling problem, bilinear) in x, embodiments of the present invention may introduce a term of the form [f(\hat{x})−g(\hat{x})]² in addition to the binary cost function H_{cost} to enforce this constraint. For inequality constraints of the form cₗ≤f(x)≤cᵤ where cₗ and cᵤ are constant lower and upper bounds and f is a polynomial in x, embodiments of the present invention first discretize the interval [cₗ, cᵤ] into evenly spaced discrete points c₁=cₗ, c₂, . . . , c_{K}=cᵤ with spacing Δc=cᵢ−cᵢ₋₁ and K being a power of 2 for convenience, and then adopt two encodings:
Unary encoding. Let b_{c}_{ⱼ} ∈ {0,1} be 1 if and only if f(\hat{x})=cⱼ. Introduce into the binary cost function a term of the form (Σⱼ₌₁^{K}b_{c}_{ⱼ}−1)²+(Σⱼ₌₁^{K}jb_{c}_{ⱼ}−f(\hat{x}))². This costs K extra bits and O(K²) scaling in the magnitude of the coefficients in the terms introduced.
Binary encoding. Introduce another binary encoding for the cᵢ terms

$$\hat{c} = {c}_{l} + k Δ c , \qquad k = {{\sum }_{t = 0}}^{{log}_{2} K - 1} {2}^{t} {β}^{( t )} , \qquad {β}^{( t )} ∈ \{ 0 , 1 \}$$

which is different from the binary expansion \hat{x}. By construction, ĉ is confined between cₗ and cᵤ. Embodiments of the present invention then introduce into the cost function a term (ĉ−f(\hat{x}))² to enforce the inequality constraint. The reasoning is that for any f(\hat{x}) that falls inside the interval [cₗ, cᵤ] there is always an appropriate assignment of ĉ to minimize the term (ĉ−f(\hat{x}))² while if f(\hat{x}) falls outside this interval there is always a non-zero lower bound in the value of the term that is impossible to optimize beyond no matter what value of ĉ is being assigned. This encoding costs only O(log K) extra bits and O(K) scaling in the magnitude of the coefficients in the terms introduced.

Although both encodings are equally valid for the current purpose, embodiments of the present invention favor this binary encoding over the more costly unary encoding. The following disclosure details how embodiments of the present invention may turn the constraints that arise in the pooling problem (1-4 and A-C) into unconstrained binary form.

Constraint 1: The definition of ŷᵢⱼ implies that its range contains all of uᵢⱼ values in the Constraint 1. The discretization that ŷᵢⱼ introduces already casts a grid on the interval

$$[ 0 , {max}_{ij} {u}_{ij} ] .$$

For each uᵢⱼ embodiments of the present invention define Uᵢⱼ as the point on the grid that is closest to uᵢⱼ but still no greater than uᵢⱼ. Formally this translates to

$${U}_{ij} = {max}_{n} \{ n \cdot {2}^{- S} U \vert n ∈ ℤ , n \cdot {2}^{- S} U \leq {u}_{ij} \} .$$

Embodiments of the present invention then use the binary encoding construction mentioned above to define a binary expansion

$${\hat{u}}_{ij} = {U}_{ij} {{\sum }_{t = 1}}^{⌈ {log}_{2} {U}_{ij} ⌉} {2}^{- t} {β}_{ij}^{( t )} , {β}_{ij}^{( t )} ∈ \{ 0 , 1 \} .$$

Then by construction 0≤ûᵢⱼ≤uᵢⱼ. Embodiments of the present invention may then convert each inequality in Constraint 1 into a term

(ŷᵢⱼ−ûᵢⱼ)²

in the binary cost function.

For Constraints 2 and 3, let

$${U}_{i} = {max}_{n} \{ n \cdot {2}^{- S} U \vert n ∈ ℤ , n \cdot {2}^{- S} U \leq {u}_{i} \}$$

for any node i ∈ I ∪ L ∪ J. Embodiments of the present invention may then (similar to Constraint 1) introduce

$${\hat{u}}_{i} = {U}_{i} {{\sum }_{t = 1}}^{⌈ {log}_{2} {U}_{i} ⌉} {2}^{- t} {β}_{ij}^{( t )} , {β}_{ij}^{( t )} ∈ \{ 0 , 1 \} .$$

Constraint 2: Embodiments of the present invention may convert the inequalities to terms

$${( {\sum }_{i ∈ I ⋃ L} {\hat{y}}_{i ℓ} - {\hat{u}}_{ℓ} )}^{2}$$

for [symbol] ∈ L and (Σ_{i∈I∪L}ŷᵢⱼ−ûⱼ)² for j ∈ J respectively.

Constraint 3: Similar to Constraints 2, embodiments of the present invention may introduce

$${( {\sum }_{ℓ ∈ L ⋃ J} {\hat{y}}_{i ℓ} - {\hat{u}}_{i} )}^{2}$$

for i ∈ I into the unconstrained binary cost function.

Constraint 4: Using the strategy for dealing with equality constraints mentioned previously, embodiments of the present invention introduce

$${( {\sum }_{i ∈ I ⋃ L} {\hat{y}}_{i ℓ} - {\sum }_{j ∈ L ⋃ J} {\hat{y}}_{ℓ j} )}^{2}$$

for each l ∈ L into the objective function.

Constraint A: The concentrations at the source nodes are already given.

Constraint B: Introduce discretization of the concentration measures pₗₖ as an Sₚ_{_{L}}-bit approximation

$${\hat{p}}_{ℓ k} = {Λ}_{k} {{\sum }_{t = 1}}^{{S}_{{p}_{L}}} {2}^{- t} {d}_{ℓ k}^{( t )} , {d}_{ℓ k}^{( t )} ∈ \{ 0 , 1 \} .$$

Here the upper bound

$${Λ}_{k} = {max}_{i} \{ {λ}_{i k} \}$$

is the maximum concentration of k supplied in any of the source node. Since the concentrations in the pool are always in the convex hull of the concentrations in the source nodes, they are bounded from above by Λₖ. To convert constraint B, the term

$${( {\sum }_{i ∈ I} {λ}_{ik} {\hat{y}}_{i ℓ} + {\sum }_{{ℓ}^{′} ∈ L ∖ \{ ℓ \}} {\hat{p}}_{{ℓ}^{′} k} {\hat{y}}_{{ℓ}^{′} ℓ} - {\hat{p}}_{ℓ k} {\sum }_{i ∈ I ⋃ L ∖ \{ ℓ \}} {\hat{y}}_{i ℓ} )}^{2}$$

is introduced into the objective function. Note that the bilinear nature of the constraint gives rise to 4^{th} order terms in bits.

Constraint C: Encode pⱼₖ into an Sₚ_{_{J}}-bit approximation

$${\hat{p}}_{jk} = {μ}_{jk}^{min} + ( {μ}_{jk}^{max} - {μ}_{jk}^{min} ) {{\sum }_{t = 1}}^{{S}_{{p}_{J}}} {2}^{- t} {d}_{ℓ k}^{( t )} , {d}_{ℓ k}^{( t )} ∈ \{ 0 , 1 \} .$$

Then by construction \hat{p}ⱼₖ is bounded between μⱼₖ^{min} and μⱼₖ^{max}. Then, encode Constraint C as a term

$${( {\sum }_{i ∈ I} {λ}_{ik} {\hat{y}}_{ij} + {\sum }_{ℓ ∈ L} {\hat{p}}_{ℓ k} {\hat{y}}_{ℓ j} - {\hat{p}}_{jk} {\sum }_{i ∈ I ⋃ L} {\hat{y}}_{ij} )}^{2}$$

for each terminal j ∈ J and concentration of ingredient k ∈ K.

Finally, embodiments of the present invention may put together the unconstrained binary cost function such that the bit string that minimizes its value encodes a solution which is ε-close to the global optimum of the pooling problem. Here ε is an error tolerance parameter that determines the number bits needed for the transformed binary optimization problem.

The full expression for the unconstrained binary cost function, as may be implemented by embodiments of the present invention, is the following:

$$\begin{matrix}H ( \hat{y} , \hat{p} ) = {\sum }_{( i , j ) ∈ A} {c}_{ij} {\hat{y}}_{ij} \\ + α [ {\sum }_{( i , j ) ∈ A} {( {\hat{y}}_{ij} - {\hat{u}}_{ij} )}^{2} + {\sum }_{ℓ ∈ L} {( {\sum }_{i ∈ I ⋃ L} {\hat{y}}_{i ℓ} - {\hat{u}}_{ℓ} )}^{2} \\ + {\sum }_{j ∈ J} {( {\sum }_{i ∈ I ⋃ L} {\hat{y}}_{ij} - {\hat{u}}_{j} )}^{2} + {\sum }_{i ∈ I} {( {\sum }_{ℓ ∈ L ⋃ J} {\hat{y}}_{i ℓ} - {\hat{u}}_{i} )}^{2} \\ + {\sum }_{ℓ ∈ L} {( {\sum }_{i ∈ I ⋃ L} {\hat{y}}_{i ℓ} - {\sum }_{j ∈ L ⋃ J} {\hat{y}}_{ℓ j} )}^{2} \\ + {\sum }_{k ∈ K} ( {\sum }_{ℓ ∈ L} {( {\sum }_{i ∈ I} {λ}_{i k} {\hat{y}}_{i ℓ} + {\sum }_{{ℓ}^{′} ∈ L ∖ \{ ℓ \}} {\hat{p}}_{{ℓ}^{′} k} {\hat{y}}_{{ℓ}^{′} ℓ} - {\hat{p}}_{ℓ k} {\sum }_{i ∈ I ⋃ L ∖ \{ ℓ \}} {\hat{y}}_{i ℓ} )}^{2} \\ + {\sum }_{j ∈ J} {( {\sum }_{i ∈ I} {λ}_{i k} {\hat{y}}_{ij} + {\sum }_{ℓ ∈ L} {\hat{p}}_{ℓ k} {\hat{y}}_{ℓ j} - {\hat{p}}_{jk} {\sum }_{i ∈ I ⋃ L} {\hat{y}}_{ij} )}^{2} ) ] .\end{matrix}$$

Here α>Σ_{(i,j)∈A}|cᵢⱼ| is a parameter that needs to be high enough to enforce the constraints.

The total number of bits introduced in the construction of the above cost function can be gleaned from inspecting the terms:

$$Total \# of bits = \vert A \vert \cdot {S}_{y} + {\sum }_{( i , j ) ∈ A} ⌈ {log}_{2} {U}_{ij} ⌉ + {\sum }_{i ∈ I ⋃ L ⋃ J} ⌈ {log}_{2} {U}_{i} ⌉ + {\sum }_{k ∈ K} ( \vert L \vert \cdot {S}_{{p}_{L}} + \vert J \vert \cdot {S}_{{p}_{J}} ) .$$

For error ε between the optimal solution to the unconstrained binary optimization problem and the global optimum of the pooling problem, the total number of bits scales as

$$O ( ( \vert A \vert + \vert N \vert ) log \frac{\vert A \vert + \vert N \vert}{ε} ) .$$

Note that the original pooling problem has O(|A|+|N|) variables. Hence, the mapping used by embodiments of the present invention only introduces a logarithmic overhead in the asymptotic scaling of the resources needed.

Embodiments of the present invention may apply the above technique to a class of problems far more general than the pooling problem. Consider the problem

$$\begin{matrix}{min}_{x} & {p}_{0} ( x ) , x ∈ {{\prod }_{i = 1}}^{n} [ {x}_{i}^{min} , {x}_{i}^{max} ] \\ {l}_{1} \leq {p}_{1} ( x ) \leq {u}_{1} \\ {l}_{2} \leq {p}_{2} ( x ) \leq {u}_{2} \\ ⋮ \\ s . t . & {l}_{m} \leq {p}_{m} ( x ) \leq {u}_{m} \\ {q}_{1} ( x ) = {c}_{1} \\ {q}_{2} ( x ) = {c}_{2} \\ ⋮ \\ {q}_{k} ( x ) = {c}_{k}\end{matrix}$$

where each function p and q is a polynomial in the variables x. A general strategy that may be applied by embodiments of the present invention is to discretize the variables using Sₓ bits, namely \hat{x}=(\hat{x}₁, \hat{x}₂, . . . , \hat{x}ₙ) with

$${\hat{x}}_{i} = {x}_{i}^{min} + ( {x}_{i}^{max} - {x}_{i}^{min} ) {\sum }_{t = 1}^{{S}_{x}} {2}^{- t} {b}_{i}^{( t )} , {b}_{i}^{( t )} ∈ \{ 0 , 1 \}$$

for some prescribed lower and upper bound xᵢ^{min} and xᵢ^{max} for xᵢ. For the i-th inequality constraint embodiments of the present invention may introduce Sᵢ^{ineq} bits to discretize the interval [lᵢ, uᵢ] and form the quantity

$${\hat{z}}_{i} = {l}_{i} + ( {u}_{i} - {l}_{i} ) {{\sum }_{t = 1}}^{{S}_{i}^{ineq}} {2}^{- t} {β}_{i}^{( t )} , {β}_{i}^{( t )} ∈ \{ 0 , 1 \} .$$

Then embodiments of the present invention may transform the original problem into an unconstrained binary optimization problem on

$$O ( n log \frac{poly ( n )}{ε} ) bits H ( \hat{x} , \hat{z} ) = {p}_{0} ( \hat{x} ) + {{\sum }_{i = 1}}^{m} {( {p}_{i} ( \hat{x} ) - {\hat{z}}_{i} )}^{2} + {{\sum }_{i = 1}}^{k} {( {q}_{i} ( \hat{x} ) - {c}_{i} )}^{2}$$

such that the global optimum H* differs from the optimal value p₀(x*) of the original problem by an error ε.

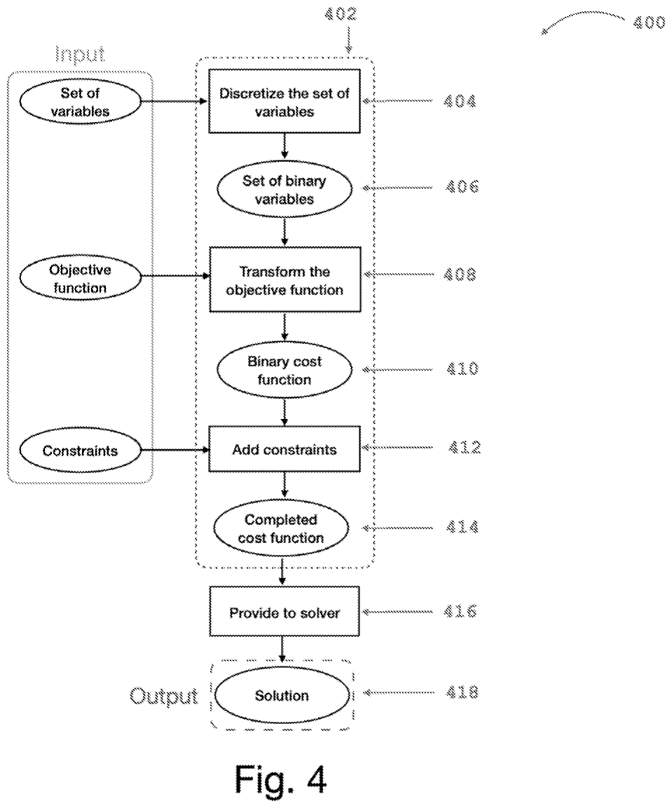

Referring to FIG. 4, a flowchart of a method 400 performed by one embodiment of the present invention for optimizing transport of a set of ingredients between a plurality of sources, at least one terminal, and a plurality of pools, described by an objective function, a set of variables, and a set of constraints. The method 400 may be performed by at least one processor executing computer program instructions stored on at least one non-transitory computer-readable medium. The method 400 includes: (A) transforming the objective function, the set of variables, and the set of constraints into a binary cost function (FIG. 4, operation 402). The transforming 402 may include: (A)(1) discretizing the set of variables into a set of a binary variables 406 (FIG. 4, operation 404); (A)(2) transforming the objective function into a binary cost function 410 of the set of binary variables 406 (FIG. 4, operation 408); and (A)(3) adding, for each constraint in the set of constraints, one or more terms to the binary cost function, to create a completed cost function 414 (FIG. 4, operation 412).

The method 400 further includes: (B) providing the completed cost function 414 to a solver to obtain a solution or approximate solution 418, wherein the solution or approximate solution 418 represents a flow of the set of ingredients between the plurality of sources, the plurality of pools, and the at least one terminal (FIG. 4, operation 416).

The solver may, for example, be implemented on a quantum computer, and providing the completed cost function to the solver may include providing the completed cost function to the solver on the quantum computer. The solver may, for example, be implemented on a digital annealer, and providing the completed cost function to the solver may include providing the completed cost function to the solver on the digital annealer. The solver may, for example, be implemented as a quantum-inspired algorithm on a classical computer, and providing the completed cost function to the solver may include providing the completed cost function to the quantum-inspired algorithm on the classical computer.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Various physical embodiments of a quantum computer are suitable for use according to the present disclosure. In general, the fundamental data storage unit in quantum computing is the quantum bit, or qubit. The qubit is a quantum-computing analog of a classical digital computer system bit. A classical bit is considered to occupy, at any given point in time, one of two possible states corresponding to the binary digits (bits) 0 or 1. By contrast, a qubit is implemented in hardware by a physical medium with quantum-mechanical characteristics. Such a medium, which physically instantiates a qubit, may be referred to herein as a “physical instantiation of a qubit,” a “physical embodiment of a qubit,” a “medium embodying a qubit,” or similar terms, or simply as a “qubit,” for ease of explanation. It should be understood, therefore, that references herein to “qubits” within descriptions of embodiments of the present invention refer to physical media which embody qubits.

Each qubit has an infinite number of different potential quantum-mechanical states. When the state of a qubit is physically measured, the measurement produces one of two different basis states resolved from the state of the qubit. Thus, a single qubit can represent a one, a zero, or any quantum superposition of those two qubit states; a pair of qubits can be in any quantum superposition of 4 orthogonal basis states; and three qubits can be in any superposition of 8 orthogonal basis states. The function that defines the quantum-mechanical states of a qubit is known as its wavefunction. The wavefunction also specifies the probability distribution of outcomes for a given measurement. A qubit, which has a quantum state of dimension two (i.e., has two orthogonal basis states), may be generalized to a d-dimensional “qudit,” where d may be any integral value, such as 2, 3, 4, or higher. In the general case of a qudit, measurement of the qudit produces one of d different basis states resolved from the state of the qudit. Any reference herein to a qubit should be understood to refer more generally to an d-dimensional qudit with any value of d.

Although certain descriptions of qubits herein may describe such qubits in terms of their mathematical properties, each such qubit may be implemented in a physical medium in any of a variety of different ways. Examples of such physical media include superconducting material, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or aggregations of any of the foregoing that exhibit qubit behavior, that is, comprising quantum states and transitions therebetween that can be controllably induced or detected.

For any given medium that implements a qubit, any of a variety of properties of that medium may be chosen to implement the qubit. For example, if electrons are chosen to implement qubits, then the x component of its spin degree of freedom may be chosen as the property of such electrons to represent the states of such qubits. Alternatively, the y component, or the z component of the spin degree of freedom may be chosen as the property of such electrons to represent the state of such qubits. This is merely a specific example of the general feature that for any physical medium that is chosen to implement qubits, there may be multiple physical degrees of freedom (e.g., the x, y, and z components in the electron spin example) that may be chosen to represent 0 and 1. For any particular degree of freedom, the physical medium may controllably be put in a state of superposition, and measurements may then be taken in the chosen degree of freedom to obtain readouts of qubit values.

Certain implementations of quantum computers, referred to as gate model quantum computers, comprise quantum gates. In contrast to classical gates, there is an infinite number of possible single-qubit quantum gates that change the state vector of a qubit. Changing the state of a qubit state vector typically is referred to as a single-qubit rotation, and may also be referred to herein as a state change or a single-qubit quantum-gate operation. A rotation, state change, or single-qubit quantum-gate operation may be represented mathematically by a unitary 2×2 matrix with complex elements. A rotation corresponds to a rotation of a qubit state within its Hilbert space, which may be conceptualized as a rotation of the Bloch sphere. (As is well-known to those having ordinary skill in the art, the Bloch sphere is a geometrical representation of the space of pure states of a qubit.) Multi-qubit gates alter the quantum state of a set of qubits. For example, two-qubit gates rotate the state of two qubits as a rotation in the four-dimensional Hilbert space of the two qubits. (As is well-known to those having ordinary skill in the art, a Hilbert space is an abstract vector space possessing the structure of an inner product that allows length and angle to be measured. Furthermore, Hilbert spaces are complete: there are enough limits in the space to allow the techniques of calculus to be used.)

A quantum circuit may be specified as a sequence of quantum gates. As described in more detail below, the term “quantum gate,” as used herein, refers to the application of a gate control signal (defined below) to one or more qubits to cause those qubits to undergo certain physical transformations and thereby to implement a logical gate operation. To conceptualize a quantum circuit, the matrices corresponding to the component quantum gates may be multiplied together in the order specified by the gate sequence to produce a 2n×2n complex matrix representing the same overall state change on n qubits. A quantum circuit may thus be expressed as a single resultant operator. However, designing a quantum circuit in terms of constituent gates allows the design to conform to a standard set of gates, and thus enable greater ease of deployment. A quantum circuit thus corresponds to a design for actions taken upon the physical components of a quantum computer.

A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In certain embodiments of quantum circuits, the quantum circuit includes both one or more gates and one or more measurement operations. Quantum computers implemented using such quantum circuits are referred to herein as implementing “measurement feedback.” For example, a quantum computer implementing measurement feedback may execute the gates in a quantum circuit and then measure only a subset (i.e., fewer than all) of the qubits in the quantum computer, and then decide which gate(s) to execute next based on the outcome(s) of the measurement(s). In particular, the measurement(s) may indicate a degree of error in the gate operation(s), and the quantum computer may decide which gate(s) to execute next based on the degree of error. The quantum computer may then execute the gate(s) indicated by the decision. This process of executing gates, measuring a subset of the qubits, and then deciding which gate(s) to execute next may be repeated any number of times. Measurement feedback may be useful for performing quantum error correction, but is not limited to use in performing quantum error correction. For every quantum circuit, there is an error-corrected implementation of the circuit with or without measurement feedback.

Some embodiments described herein generate, measure, or utilize quantum states that approximate a target quantum state (e.g., a ground state of a Hamiltonian). As will be appreciated by those trained in the art, there are many ways to quantify how well a first quantum state “approximates” a second quantum state. In the following description, any concept or definition of approximation known in the art may be used without departing from the scope hereof. For example, when the first and second quantum states are represented as first and second vectors, respectively, the first quantum state approximates the second quantum state when an inner product between the first and second vectors (called the “fidelity” between the two quantum states) is greater than a predefined amount (typically labeled ϵ). In this example, the fidelity quantifies how “close” or “similar” the first and second quantum states are to each other. The fidelity represents a probability that a measurement of the first quantum state will give the same result as if the measurement were performed on the second quantum state. Proximity between quantum states can also be quantified with a distance measure, such as a Euclidean norm, a Hamming distance, or another type of norm known in the art. Proximity between quantum states can also be defined in computational terms. For example, the first quantum state approximates the second quantum state when a polynomial time-sampling of the first quantum state gives some desired information or property that it shares with the second quantum state.

Not all quantum computers are gate model quantum computers. Embodiments of the present invention are not limited to being implemented using gate model quantum computers. As an alternative example, embodiments of the present invention may be implemented, in whole or in part, using a quantum computer that is implemented using a quantum annealing architecture, which is an alternative to the gate model quantum computing architecture. More specifically, quantum annealing (QA) is a metaheuristic for finding the global minimum of a given objective function over a given set of candidate solutions (candidate states), by a process using quantum fluctuations.

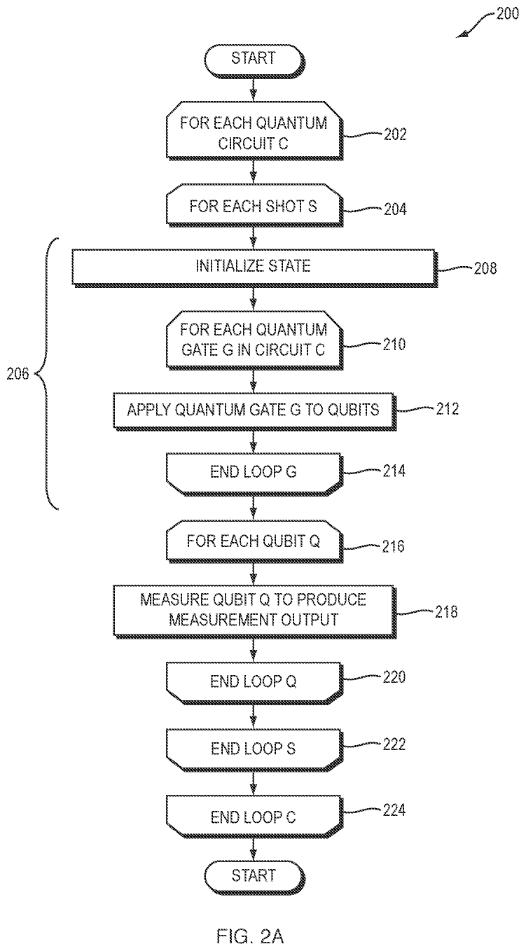

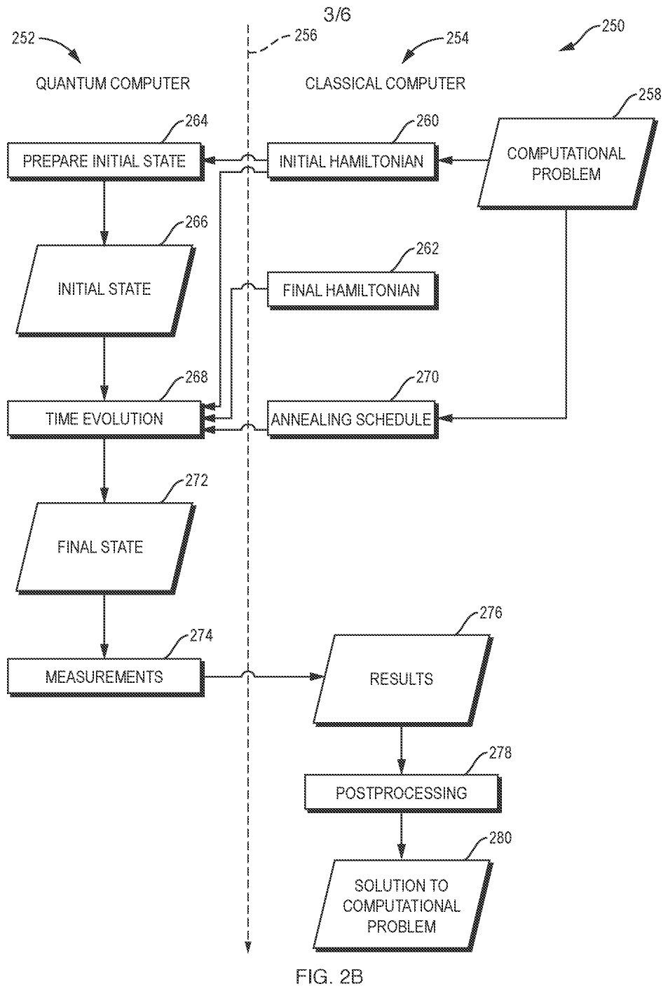

FIG. 2B shows a diagram illustrating operations typically performed by a computer system 250 which implements quantum annealing. The system 250 includes both a quantum computer 252 and a classical computer 254. Operations shown on the left of the dashed vertical line 256 typically are performed by the quantum computer 252, while operations shown on the right of the dashed vertical line 256 typically are performed by the classical computer 254.

Quantum annealing starts with the classical computer 254 generating an initial Hamiltonian 260 and a final Hamiltonian 262 based on a computational problem 258 to be solved, and providing the initial Hamiltonian 260, the final Hamiltonian 262 and an annealing schedule 270 as input to the quantum computer 252. The quantum computer 252 prepares a well-known initial state 266 (FIG. 2B, operation 264), such as a quantum-mechanical superposition of all possible states (candidate states) with equal weights, based on the initial Hamiltonian 260. The classical computer 254 provides the initial Hamiltonian 260, a final Hamiltonian 262, and an annealing schedule 270 to the quantum computer 252. The quantum computer 252 starts in the initial state 266, and evolves its state according to the annealing schedule 270 following the time-dependent Schrödinger equation, a natural quantum-mechanical evolution of physical systems (FIG. 2B, operation 268). More specifically, the state of the quantum computer 252 undergoes time evolution under a time-dependent Hamiltonian, which starts from the initial Hamiltonian 260 and terminates at the final Hamiltonian 262. If the rate of change of the system Hamiltonian is slow enough, the system stays close to the ground state of the instantaneous Hamiltonian. If the rate of change of the system Hamiltonian is accelerated, the system may leave the ground state temporarily but produce a higher likelihood of concluding in the ground state of the final problem Hamiltonian, i.e., diabatic quantum computation. At the end of the time evolution, the set of qubits on the quantum annealer is in a final state 272, which is expected to be close to the ground state of the classical Ising model that corresponds to the solution to the original optimization problem 258. An experimental demonstration of the success of quantum annealing for random magnets was reported immediately after the initial theoretical proposal.

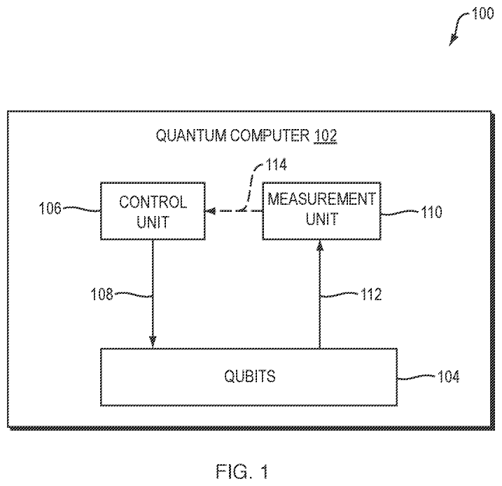

The final state 272 of the quantum computer 252 is measured, thereby producing results 276 (i.e., measurements) (FIG. 2B, operation 274). The measurement operation 274 may be performed, for example, in any of the ways disclosed herein, such as in any of the ways disclosed herein in connection with the measurement unit 110 in FIG. 1. The classical computer 254 performs postprocessing on the measurement results 276 to produce output 280 representing a solution to the original computational problem 258 (FIG. 2B, operation 278).

As yet another alternative example, embodiments of the present invention may be implemented, in whole or in part, using a quantum computer that is implemented using a one-way quantum computing architecture, also referred to as a measurement-based quantum computing architecture, which is another alternative to the gate model quantum computing architecture. More specifically, the one-way or measurement based quantum computer (MBQC) is a method of quantum computing that first prepares an entangled resource state, usually a cluster state or graph state, then performs single qubit measurements on it. It is “one-way” because the resource state is destroyed by the measurements.

The outcome of each individual measurement is random, but they are related in such a way that the computation always succeeds. In general the choices of basis for later measurements need to depend on the results of earlier measurements, and hence the measurements cannot all be performed at the same time.

Any of the functions disclosed herein may be implemented using means for performing those functions. Such means include, but are not limited to, any of the components disclosed herein, such as the computer-related components described below.

Referring to FIG. 1, a diagram is shown of a system 100 implemented according to one embodiment of the present invention. Referring to FIG. 2A, a flowchart is shown of a method 200 performed by the system 100 of FIG. 1 according to one embodiment of the present invention. The system 100 includes a quantum computer 102. The quantum computer 102 includes a plurality of qubits 104, which may be implemented in any of the ways disclosed herein. There may be any number of qubits 104 in the quantum computer 102. For example, the qubits 104 may include or consist of no more than 2 qubits, no more than 4 qubits, no more than 8 qubits, no more than 16 qubits, no more than 32 qubits, no more than 64 qubits, no more than 128 qubits, no more than 256 qubits, no more than 512 qubits, no more than 1024 qubits, no more than 2048 qubits, no more than 4096 qubits, or no more than 8192 qubits. These are merely examples, in practice there may be any number of qubits 104 in the quantum computer 102.

There may be any number of gates in a quantum circuit. However, in some embodiments the number of gates may be at least proportional to the number of qubits 104 in the quantum computer 102. In some embodiments the gate depth may be no greater than the number of qubits 104 in the quantum computer 102, or no greater than some linear multiple of the number of qubits 104 in the quantum computer 102 (e.g., 2, 3, 4, 5, 6, or 7).

The qubits 104 may be interconnected in any graph pattern. For example, they be connected in a linear chain, a two-dimensional grid, an all-to-all connection, any combination thereof, or any subgraph of any of the preceding.

As will become clear from the description below, although element 102 is referred to herein as a “quantum computer,” this does not imply that all components of the quantum computer 102 leverage quantum phenomena. One or more components of the quantum computer 102 may, for example, be classical (i.e., non-quantum components) components which do not leverage quantum phenomena.

The quantum computer 102 includes a control unit 106, which may include any of a variety of circuitry and/or other machinery for performing the functions disclosed herein. The control unit 106 may, for example, consist entirely of classical components. The control unit 106 generates and provides as output one or more control signals 108 to the qubits 104. The control signals 108 may take any of a variety of forms, such as any kind of electromagnetic signals, such as electrical signals, magnetic signals, optical signals (e.g., laser pulses), or any combination thereof.

For example:
In embodiments in which some or all of the qubits 104 are implemented as photons (also referred to as a “quantum optical” implementation) that travel along waveguides, the control unit 106 may be a beam splitter (e.g., a heater or a mirror), the control signals 108 may be signals that control the heater or the rotation of the mirror, the measurement unit 110 may be a photodetector, and the measurement signals 112 may be photons.
In embodiments in which some or all of the qubits 104 are implemented as charge type qubits (e.g., transmon, X-mon, G-mon) or flux-type qubits (e.g., flux qubits, capacitively shunted flux qubits) (also referred to as a “circuit quantum electrodynamic” (circuit QED) implementation), the control unit 106 may be a bus resonator activated by a drive, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as superconducting circuits, the control unit 106 may be a circuit QED-assisted control unit or a direct capacitive coupling control unit or an inductive capacitive coupling control unit, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as trapped ions (e.g., electronic states of, e.g., magnesium ions), the control unit 106 may be a laser, the control signals 108 may be laser pulses, the measurement unit 110 may be a laser and either a CCD or a photodetector (e.g., a photomultiplier tube), and the measurement signals 112 may be photons.
In embodiments in which some or all of the qubits 104 are implemented using nuclear magnetic resonance (NMR) (in which case the qubits may be molecules, e.g., in liquid or solid form), the control unit 106 may be a radio frequency (RF) antenna, the control signals 108 may be RF fields emitted by the RF antenna, the measurement unit 110 may be another RF antenna, and the measurement signals 112 may be RF fields measured by the second RF antenna.
In embodiments in which some or all of the qubits 104 are implemented as nitrogen-vacancy centers (NV centers), the control unit 106 may, for example, be a laser, a microwave antenna, or a coil, the control signals 108 may be visible light, a microwave signal, or a constant electromagnetic field, the measurement unit 110 may be a photodetector, and the measurement signals 112 may be photons.
In embodiments in which some or all of the qubits 104 are implemented as two-dimensional quasiparticles called “anyons” (also referred to as a “topological quantum computer” implementation), the control unit 106 may be nanowires, the control signals 108 may be local electrical fields or microwave pulses, the measurement unit 110 may be superconducting circuits, and the measurement signals 112 may be voltages.
In embodiments in which some or all of the qubits 104 are implemented as semiconducting material (e.g., nanowires), the control unit 106 may be microfabricated gates, the control signals 108 may be RF or microwave signals, the measurement unit 110 may be microfabricated gates, and the measurement signals 112 may be RF or microwave signals.

Although not shown explicitly in FIG. 1 and not required, the measurement unit 110 may provide one or more feedback signals 114 to the control unit 106 based on the measurement signals 112. For example, quantum computers referred to as “one-way quantum computers” or “measurement-based quantum computers” utilize such feedback 114 from the measurement unit 110 to the control unit 106. Such feedback 114 is also necessary for the operation of fault-tolerant quantum computing and error correction.

The control signals 108 may, for example, include one or more state preparation signals which, when received by the qubits 104, cause some or all of the qubits 104 to change their states. Such state preparation signals constitute a quantum circuit also referred to as an “ansatz circuit.” The resulting state of the qubits 104 is referred to herein as an “initial state” or an “ansatz state.” The process of outputting the state preparation signal(s) to cause the qubits 104 to be in their initial state is referred to herein as “state preparation” (FIG. 2A, section 206). A special case of state preparation is “initialization,” also referred to as a “reset operation,” in which the initial state is one in which some or all of the qubits 104 are in the “zero” state i.e. the default single-qubit state. More generally, state preparation may involve using the state preparation signals to cause some or all of the qubits 104 to be in any distribution of desired states. In some embodiments, the control unit 106 may first perform initialization on the qubits 104 and then perform preparation on the qubits 104, by first outputting a first set of state preparation signals to initialize the qubits 104, and by then outputting a second set of state preparation signals to put the qubits 104 partially or entirely into non-zero states.

Another example of control signals 108 that may be output by the control unit 106 and received by the qubits 104 are gate control signals. The control unit 106 may output such gate control signals, thereby applying one or more gates to the qubits 104. Applying a gate to one or more qubits causes the set of qubits to undergo a physical state change which embodies a corresponding logical gate operation (e.g., single-qubit rotation, two-qubit entangling gate or multi-qubit operation) specified by the received gate control signal. As this implies, in response to receiving the gate control signals, the qubits 104 undergo physical transformations which cause the qubits 104 to change state in such a way that the states of the qubits 104, when measured (see below), represent the results of performing logical gate operations specified by the gate control signals. The term “quantum gate,” as used herein, refers to the application of a gate control signal to one or more qubits to cause those qubits to undergo the physical transformations described above and thereby to implement a logical gate operation.

It should be understood that the dividing line between state preparation (and the corresponding state preparation signals) and the application of gates (and the corresponding gate control signals) may be chosen arbitrarily. For example, some or all the components and operations that are illustrated in FIGS. 1 and 2A-2B as elements of “state preparation” may instead be characterized as elements of gate application. Conversely, for example, some or all of the components and operations that are illustrated in FIGS. 1 and 2A-2B as elements of “gate application” may instead be characterized as elements of state preparation. As one particular example, the system and method of FIGS. 1 and 2A-2B may be characterized as solely performing state preparation followed by measurement, without any gate application, where the elements that are described herein as being part of gate application are instead considered to be part of state preparation. Conversely, for example, the system and method of FIGS. 1 and 2A-2B may be characterized as solely performing gate application followed by measurement, without any state preparation, and where the elements that are described herein as being part of state preparation are instead considered to be part of gate application.

The quantum computer 102 also includes a measurement unit 110, which performs one or more measurement operations on the qubits 104 to read out measurement signals 112 (also referred to herein as “measurement results”) from the qubits 104, where the measurement results 112 are signals representing the states of some or all of the qubits 104. In practice, the control unit 106 and the measurement unit 110 may be entirely distinct from each other, or contain some components in common with each other, or be implemented using a single unit (i.e., a single unit may implement both the control unit 106 and the measurement unit 110). For example, a laser unit may be used both to generate the control signals 108 and to provide stimulus (e.g., one or more laser beams) to the qubits 104 to cause the measurement signals 112 to be generated.

In general, the quantum computer 102 may perform various operations described above any number of times. For example, the control unit 106 may generate one or more control signals 108, thereby causing the qubits 104 to perform one or more quantum gate operations. The measurement unit 110 may then perform one or more measurement operations on the qubits 104 to read out a set of one or more measurement signals 112. The measurement unit 110 may repeat such measurement operations on the qubits 104 before the control unit 106 generates additional control signals 108, thereby causing the measurement unit 110 to read out additional measurement signals 112 resulting from the same gate operations that were performed before reading out the previous measurement signals 112. The measurement unit 110 may repeat this process any number of times to generate any number of measurement signals 112 corresponding to the same gate operations. The quantum computer 102 may then aggregate such multiple measurements of the same gate operations in any of a variety of ways.

After the measurement unit 110 has performed one or more measurement operations on the qubits 104 after they have performed one set of gate operations, the control unit 106 may generate one or more additional control signals 108, which may differ from the previous control signals 108, thereby causing the qubits 104 to perform one or more additional quantum gate operations, which may differ from the previous set of quantum gate operations. The process described above may then be repeated, with the measurement unit 110 performing one or more measurement operations on the qubits 104 in their new states (resulting from the most recently-performed gate operations).

In general, the system 100 may implement a plurality of quantum circuits as follows. For each quantum circuit C in the plurality of quantum circuits (FIG. 2A, operation 202), the system 100 performs a plurality of “shots” on the qubits 104. The meaning of a shot will become clear from the description that follows. For each shot S in the plurality of shots (FIG. 2A, operation 204), the system 100 prepares the state of the qubits 104 (FIG. 2A, section 206). More specifically, for each quantum gate G in quantum circuit C (FIG. 2A, operation 210), the system 100 applies quantum gate G to the qubits 104 (FIG. 2A, operations 212 and 214).

Then, for each of the qubits Q 104 (FIG. 2A, operation 216), the system 100 measures the qubit Q to produce measurement output representing a current state of qubit Q (FIG. 2A, operations 218 and 220).

The operations described above are repeated for each shot S (FIG. 2A, operation 222), and circuit C (FIG. 2A, operation 224). As the description above implies, a single “shot” involves preparing the state of the qubits 104 and applying all of the quantum gates in a circuit to the qubits 104 and then measuring the states of the qubits 104; and the system 100 may perform multiple shots for one or more circuits.

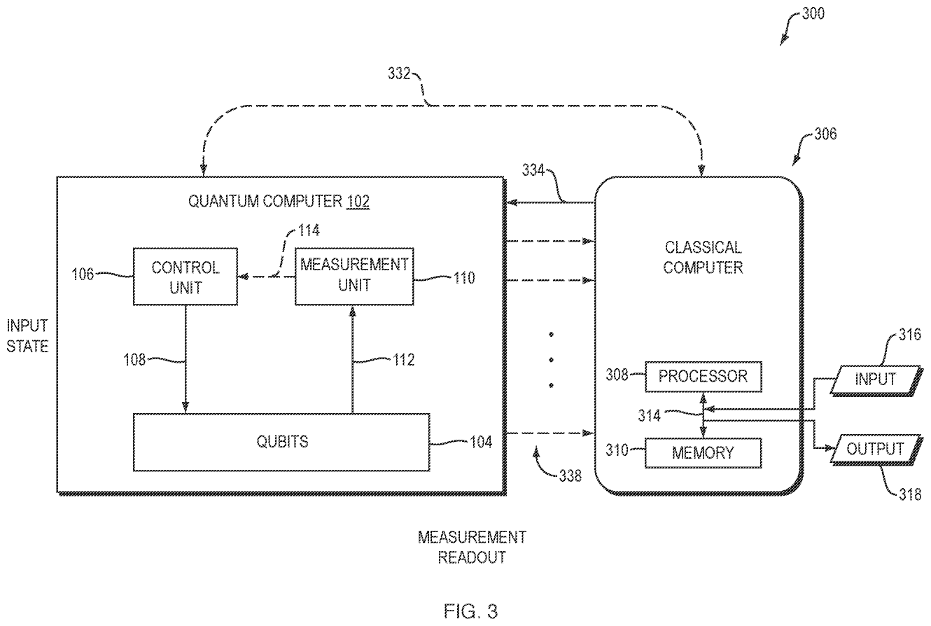

Referring to FIG. 3, a diagram is shown of a hybrid classical quantum computer (HQC) 300 implemented according to one embodiment of the present invention. The HQC 300 includes a quantum computer component 102 (which may, for example, be implemented in the manner shown and described in connection with FIG. 1) and a classical computer component 306. The classical computer component may be a machine implemented according to the general computing model established by John Von Neumann, in which programs are written in the form of ordered lists of instructions and stored within a classical (e.g., digital) memory 310 and executed by a classical (e.g., digital) processor 308 of the classical computer. The memory 310 is classical in the sense that it stores data in a storage medium in the form of bits, which have a single definite binary state at any point in time. The bits stored in the memory 310 may, for example, represent a computer program. The classical computer component 304 typically includes a bus 314. The processor 308 may read bits from and write bits to the memory 310 over the bus 314. For example, the processor 308 may read instructions from the computer program in the memory 310, and may optionally receive input data 316 from a source external to the computer 302, such as from a user input device such as a mouse, keyboard, or any other input device. The processor 308 may use instructions that have been read from the memory 310 to perform computations on data read from the memory 310 and/or the input 316, and generate output from those instructions. The processor 308 may store that output back into the memory 310 and/or provide the output externally as output data 318 via an output device, such as a monitor, speaker, or network device.

The quantum computer component 102 may include a plurality of qubits 104, as described above in connection with FIG. 1. A single qubit may represent a one, a zero, or any quantum superposition of those two qubit states. The classical computer component 304 may provide classical state preparation signals Y32 to the quantum computer 102, in response to which the quantum computer 102 may prepare the states of the qubits 104 in any of the ways disclosed herein, such as in any of the ways disclosed in connection with FIGS. 1 and 2A-2B.

Once the qubits 104 have been prepared, the classical processor 308 may provide classical control signals Y34 to the quantum computer 102, in response to which the quantum computer 102 may apply the gate operations specified by the control signals Y32 to the qubits 104, as a result of which the qubits 104 arrive at a final state. The measurement unit 110 in the quantum computer 102 (which may be implemented as described above in connection with FIGS. 1 and 2A-2B) may measure the states of the qubits 104 and produce measurement output Y38 representing the collapse of the states of the qubits 104 into one of their eigenstates. As a result, the measurement output Y38 includes or consists of bits and therefore represents a classical state. The quantum computer 102 provides the measurement output Y38 to the classical processor 308. The classical processor 308 may store data representing the measurement output Y38 and/or data derived therefrom in the classical memory 310.

The steps described above may be repeated any number of times, with what is described above as the final state of the qubits 104 serving as the initial state of the next iteration. In this way, the classical computer 304 and the quantum computer 102 may cooperate as co-processors to perform joint computations as a single computer system.

Although certain functions may be described herein as being performed by a classical computer and other functions may be described herein as being performed by a quantum computer, these are merely examples and do not constitute limitations of the present invention. A subset of the functions which are disclosed herein as being performed by a quantum computer may instead be performed by a classical computer. For example, a classical computer may execute functionality for emulating a quantum computer and provide a subset of the functionality described herein, albeit with functionality limited by the exponential scaling of the simulation. Functions which are disclosed herein as being performed by a classical computer may instead be performed by a quantum computer.

The techniques described above may be implemented, for example, in hardware, in one or more computer programs tangibly stored on one or more computer-readable media, firmware, or any combination thereof, such as solely on a quantum computer, solely on a classical computer, or on a hybrid classical quantum (HQC) computer. The techniques disclosed herein may, for example, be implemented solely on a classical computer, in which the classical computer emulates the quantum computer functions disclosed herein.

The techniques described above may be implemented in one or more computer programs executing on (or executable by) a programmable computer (such as a classical computer, a quantum computer, or an HQC) including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, a binary function of only 100 variables has 2\hat{ }100 potential solutions, which for a brute force calculation would require longer than the lifetime of the universe to verify even if a solution is checked every nanosecond. Heuristics and computer-implemented algorithms such as embodiments of the present invention are necessary to find viable solutions efficiently.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

In embodiments in which a classical computing component executes a computer program providing any subset of the functionality within the scope of the claims below, the computer program may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor, which may be either a classical processor or a quantum processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A classical computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium (such as a classical computer-readable medium, a quantum computer-readable medium, or an HQC computer-readable medium). Embodiments of the invention may store such data in such data structure(s) and read such data from such data structure(s).

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

1. A method for optimizing transport of a set of ingredients between a plurality of sources, at least one terminal, and a plurality of pools, described by an objective function, a set of variables, and a set of constraints, the method performed by at least one processor executing computer program instructions stored on at least one non-transitory computer-readable medium, the method comprising:
(A) transforming the objective function, the set of variables, and the set of constraints into a binary cost function, the transforming comprising:
(A)(1) discretizing the set of variables into a set of a binary variables;
(A)(2) transforming the objective function into a binary cost function of the set of binary variables; and
(A)(3) adding, for each constraint in the set of constraints, one or more terms to the binary cost function, to create a completed cost function; and
(B) providing the completed cost function to a solver to obtain a solution or approximate solution wherein the solution or approximate solution represents a flow of the set of ingredients between the plurality of sources, the plurality of pools, and the at least one terminal.

2. The method of claim 1, wherein the solver is implemented on a quantum computer, and wherein providing the completed cost function to the solver comprises providing the completed cost function to the solver on the quantum computer.

3. The method of claim 1, wherein the solver is implemented on a digital annealer, and wherein providing the completed cost function to the solver comprises providing the completed cost function to the solver on the digital annealer.

4. The method of claim 1, wherein the solver is implemented as a quantum-inspired algorithm on a classical computer, and wherein providing the completed cost function to the solver comprises providing the completed cost function to the quantum-inspired algorithm on the classical computer.

5. A system comprising at least one non-transitory computer-readable medium having computer program instructions stored thereon, the computer program instructions being executable by at least one processor to perform a method for optimizing transport of a set of ingredients between a plurality of sources, at least one terminal, and a plurality of pools, described by an objective function, a set of variables, and a set of constraints, the method comprising:
(A) transforming the objective function, the set of variables, and the set of constraints into a binary cost function, the transforming comprising:
(A)(1) discretizing the set of variables into a set of a binary variables;
(A)(2) transforming the objective function into a binary cost function of the set of binary variables; and
(A)(3) adding, for each constraint in the set of constraints, one or more terms to the binary cost function, to create a completed cost function; and
(B) providing the completed cost function to a solver to obtain a solution or approximate solution wherein the solution or approximate solution represents a flow of the set of ingredients between the plurality of sources, the plurality of pools, and the at least one terminal.

6. The system of claim 5, wherein the solver is implemented on a quantum computer, and wherein providing the completed cost function to the solver comprises providing the completed cost function to the solver on the quantum computer.

7. The system of claim 5, wherein the solver is implemented on a digital annealer, and wherein providing the completed cost function to the solver comprises providing the completed cost function to the solver on the digital annealer.

8. The system of claim 5, wherein the solver is implemented as a quantum-inspired algorithm on a classical computer, and wherein providing the completed cost function to the solver comprises providing the completed cost function to the quantum-inspired algorithm on the classical computer.
